(19) United States
(12) Patent Application Publication
(10) Pub. No.: US 2024/0364021 A1
(43) Pub. Date: Oct. 31, 2024

(54) AIR-STRIP LINE AND ANTENNA DEVICE COMPRISING AIR-STRIP LINE

(71) Applicant: KMW INC., Hwaseong-si Gyeonggi-do (KR)

(72) Inventors: Sung Hwan SO, Hwaseong-si (KR); Oh Seog CHOI, Hwaseong-si (KR); Yong Won SEO, Hwaseong-si (KR); Seong Man KANG, Hwaseong-Si (KR); Hyoung Seok YANG, Hwaseong-si (KR); Eui Seong CHOI, Hwaseong-si (KR); Hwa Yeol JANG, Incheon (KR); Myung Hwa KIM, Hwaseong-si (KR); Jang Soon PARK, Hwaseong-si (KR); Yong Sang LEE, Yongin-si (KR)

(73) Assignee: KMW INC., Hwaseong-si Gyeonggi-do (KR)

(21) Appl. No.: 18/764,416

(22) Filed: Jul. 5, 2024

Related U.S. Application Data
(63) Continuation of application No. PCT/KR2023/000349, filed on Jan. 9, 2023.

(30) Foreign Application Priority Data
Jan. 7, 2022 (KR) 10-2022-0002899
Apr. 1, 2022 (KR) 10-2022-0041049

(51) Int. Cl. H01Q 21/00; H01Q 1/42; H01Q 9/04

(52) U.S. Cl. CPC H01Q 21/0087; H01Q 1/422; H01Q 9/0485

(57) ABSTRACT

According to one embodiment of the present disclosure, an antenna device comprising: a plate; a first dielectric plate coupled to one surface of the plate; a plurality of radiation elements arranged along a first direction on the first dielectric plate; and a plurality of first feed lines configured to supply power to the plurality of radiation elements and having an air-strip line structure, wherein the first dielectric plate includes a first groove penetrating upper and lower surfaces of the first dielectric plate and configured to allow the first feed line to float therein, and the first feed line is configured to float in the first groove.

### TECHNICAL FIELD

The present disclosure relates to an air-strip line and an antenna device including the air-strip line.

### BACKGROUND ART

The content described in this section merely provides background information related to one embodiment of the present disclosure and does not constitute prior art.

The antenna device may include a plate, a radiation element, and a feed line that supplies power to the radiation element. The size of the radiation element may vary depending on the frequency of use. For example, as the operating frequency increases, the size of the radiation element decreases.

Multiple feed lines may be printed in a pattern on a substrate. However, since the substrate is made of a PCB material (for example, FR4 material) with a predetermined dielectric constant, the insertion loss due to the multiple pattern-printed feed lines increases, which deteriorates the performance of the antenna device.

Loss due to feed lines can be divided into conductor loss in the conductor through which the signal flows and dielectric loss due to the dielectric surrounding the conductor. The loss directly reduces the gain of the antenna device. In order to improve the gain of the antenna device, it is necessary to improve the loss, and since changing or deforming the medium is relatively advantageous, improving the dielectric loss is effective.

A representative example of the feed line used to improve dielectric loss is an air-strip line structure. The air-strip line structure refers to a feed line structure in which the dielectric portion is implemented as air.

In a feed line of the air-strip line structure, the dielectric loss is close to 0 because the conductor is surrounded by air. Therefore, when using a feed line of the air-strip line structure, the dielectric loss can be reduced, which increases the gain of the antenna device.

In a conventional air-strip line structure, the impedance can be varied by adjusting the width of the feed line. However, in the conventional air-strip line structure, the width of the feed line is wider for the same impedance compared to the PCB type, so adjusting the width of the feed line to vary the impedance has limitations in the design of the antenna device.

In addition, when the width of the feed line is adjusted, a height difference may occur between the feed lines during processing, and the characteristics of the antenna device may be deteriorated due to the height difference.

### DETAILED DESCRIPTION OF INVENTION

### Technical Problems

According to one embodiment of the present disclosure, the present disclosure provides an antenna device capable of adjusting the distance between a feed line and a dielectric plate and the thickness of the dielectric plate.

According to one embodiment of the present disclosure, the present disclosure provides an antenna device capable of configuring a circuit by changing only the structure of the dielectric while reducing the change in the width of the feed line.

The objects to be achieved by the present disclosure are not limited to the objects mentioned above, and other objects not mentioned will be clearly understood by a person of ordinary skill in the art from the description below.

### Technical Solution

According to one embodiment of the present disclosure, an antenna device comprising: a plate; a first dielectric plate coupled to one surface of the plate; a plurality of radiation elements arranged along a first direction on the first dielectric plate; and a plurality of first feed lines configured to supply power to the plurality of radiation elements and having an air-strip line structure, wherein the first dielectric plate includes a first groove penetrating upper and lower surfaces of the first dielectric plate and configured to allow the first feed line to float therein, and the first feed line is configured to float in the first groove.

According to one embodiment of the present disclosure, a feed line of an air-strip line structure which supplies power to a radiation element of an antenna device, the feed line comprising: a dielectric plate; a groove formed to penetrate through upper and lower surfaces of the dielectric plate; and a line unit configured to float at a predetermined distance from a side wall of the groove.

### Effect of Invention

According to one embodiment, the antenna device can vary the impedance by adjusting the distance between the feed line and the dielectric plate and the thickness of the dielectric plate.

According to one embodiment, the antenna device can minimize the height difference that occurs when manufacturing the feed line by reducing the change in the width of the feed line.

### BRIEF DESCRIPTION OF THE DRAWING

FIG. 1 is a combined perspective view of an antenna device according to one embodiment of the present disclosure.

FIG. 2 is an exploded perspective view of the antenna device according to one embodiment of the present disclosure.

FIG. 3 is an enlarged top view of part B of FIG. 1.

FIG. 4 is a cross-sectional view taken along line AA′ of FIG. 1 and a graph showing the change in impedance according to the distance between a feed line and a dielectric plate.

FIG. 5 is a graph showing a dielectric portion added to the bottom of the feed line and a change in impedance depending on the thickness of the dielectric portion according to one embodiment of the present disclosure.

FIG. 6 is a combined perspective view of an antenna device according to another embodiment of the present disclosure.

FIG. 7 is an exploded perspective view of the antenna device according to another embodiment of the present disclosure.

FIG. 8 is a bottom view of the antenna device according to another embodiment of the present disclosure.

FIGS. 9A and 9B are diagrams showing the connection relationship of feed lines according to one embodiment of the present disclosure.

### MODE FOR CARRYING OUT THE INVENTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, i), ii), (a), (b), a), b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

In the present specification, “upper surface” or “upper portion” refers to the direction in which radiation elements 14, 24 are coupled in antenna devices 1, 2, and “bottom surface” or “bottom portion” refers to the direction in which plates 11, 21 are coupled in the antenna devices 1, 2.

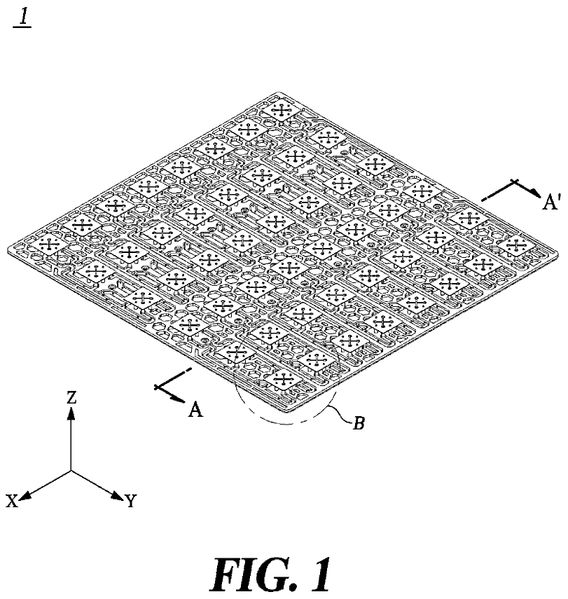

FIG. 1 is a combined perspective view of an antenna device according to one embodiment of the present disclosure.

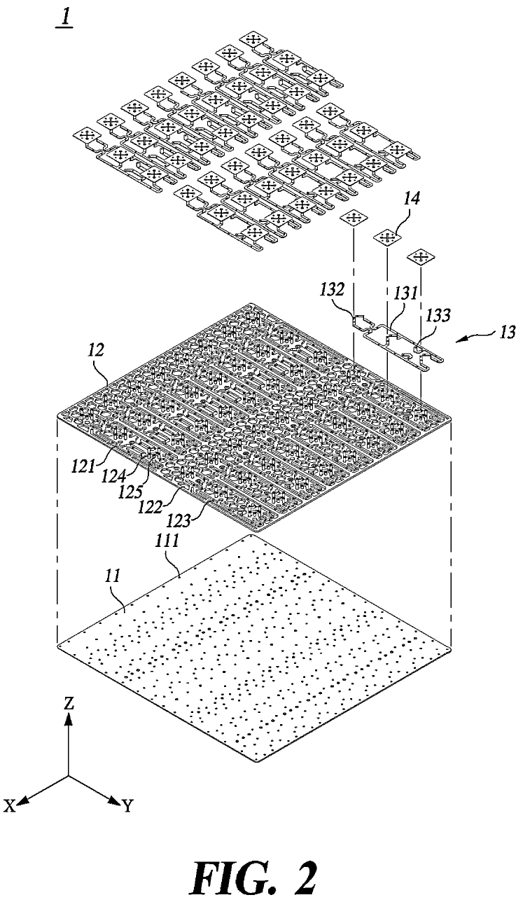

FIG. 2 is an exploded perspective view of the antenna device according to one embodiment of the present disclosure.

Referring to FIGS. 1 and 2, an antenna device 1 may include all or some of a plate 11, a first dielectric plate 12, a first feed line 13, and a plurality of radiation elements 14.

The first dielectric plate 12 may be coupled to an upper surface of the plate 11. The plate 11 may be made of a metallic material and may provide a ground plane for the radiation elements 14 of the antenna device 1.

The plate 11 may include a plurality of holes 111. The plurality of holes 111 may be formed to penetrate the plate 11. The plurality of holes 111 may include a plurality of first holes and a plurality of second holes. Protrusions (not shown) of the first dielectric plate 12 are inserted into the plurality of first holes, so that the plate 11 and the first dielectric plate 12 can be coupled. RF filters, connectors, ports, etc. may be coupled in the plurality of second holes to be connected to the antenna device 1.

The first dielectric plate 12 may include all or some of a first groove 121, a second groove 122, a first support unit 123, a first connection unit 124, a second connection unit 125, and a protrusion (not shown).

The first dielectric plate 12 may be formed on the upper surface of the plate 11 through injection. Thus, all or some of the components of the first dielectric plate 12, the first groove 121, the second groove 122, the first support unit 123, the first connection unit 124, the second connection unit 125, and the protrusions may be formed integrally. In this case, the first dielectric plate 12 may be made of a dielectric, e.g., plastic material.

The first groove 121 may be formed to penetrate the upper and lower surfaces of the first dielectric plate 12. The first groove 121 may extend longitudinally along a first direction. In this case, the first direction is a direction parallel to the Y-axis of FIG. 1. The first groove 121 may be formed to correspond to the shape of the first feed line 13, which will be described later, so that the first feed line 13 can float in the first groove 121.

The first feed line 13 may be configured to float in the first groove 121. For example, the first feed line 13 may float at a predetermined distance from the side wall of the first groove 121. In addition, the first feed line 13 may float at a predetermined distance from the plate 11 coupled to the lower surface of the first dielectric plate 12.

The space between the first feed line 13 and the side wall of the first groove 121 and/or the plate 11 may be filled with air. That is, the first feed line 13 may have an air-strip line structure. The air-strip line structure refers to a structure in which the dielectric portion is implemented as air in a general stripline structure.

In the feed line 13 of the air-strip line structure, the dielectric loss is close to ‘0’ because the conductor is surrounded by air. Therefore, the gain of the antenna device 1 can be increased by reducing the dielectric loss.

The first support unit 123 may be formed in the first groove 121. The first support unit 123 is formed at the bottom of the first groove 121 and may connect opposing side walls of the first groove 121. The first support unit 123 may be connected to the first groove 121 and formed integrally with the first dielectric plate 12, but a thickness of the first support unit 123 may be thinner than a thickness of the first groove 121. The first support unit 123 may be formed in the first groove 121 at predetermined intervals along the first direction.

The first feed line 13 may be coupled to upper surfaces of a plurality of first support units 123 formed at predetermined intervals. As the first feed line 13 is coupled to the upper surfaces of the first support unit 123, the first feed line 13 may float at a predetermined distance from the side wall of the first groove 121 and/or the plate 11. That is, by using the first support unit 123, an air-strip line structure can be formed using only a minimum amount of dielectric.

The second groove 122 may be formed in at least a portion of the first dielectric plate 12 where the first groove 121 is not formed. The second groove 122 may be formed to penetrate the upper and lower surfaces of the first dielectric plate 12. The second groove 122 may be formed regularly with a predetermined pattern. For example, the second groove 122 may be formed in a honeycomb-shaped pattern. However, the present disclosure is not limited to the above, and the second groove 122 may be formed irregularly. By forming a plurality of second grooves 122 in the first dielectric plate 12, the weight of the first dielectric plate 12 can be lightened and the manufacturing cost of the antenna device 1 can be reduced.

The first connection unit 124 may be formed to protrude from the upper surface of the first dielectric plate 12. The first connection unit 124 may connect the first dielectric plate 12 and the radiation element 14. Four first connection units 124 may be formed at predetermined intervals to connect the first dielectric plate 12 and the radiation element 14. For example, the four first connection units 124 may be arranged to form a square shape. However, the present disclosure is not limited to the above, and the number and arrangement of the first connection units 124 may be designed in various ways as needed.

The second connection unit 125 may be formed to protrude from the upper surface of the first dielectric plate 12. The second connection unit 125 may connect the first dielectric plate 12 and the first feed line 13. The second connection unit 125 may be formed below the radiation element 14 so that the first feed line 13 can feed the radiation element 14. That is, the height of the second connection unit 125 may be lower than the height of the first connection unit 124. In order to connect a pair of first feed lines 13, the second connection units 125 may be formed as a pair. However, the present disclosure is not limited to the above, and the number and arrangement of the second connection units 125 may be designed in various ways as needed.

The protrusion may be formed on the lower surface of the first dielectric plate 12. The protrusion is formed to protrude from the lower surface of the first dielectric plate 12 and can be inserted into the hole 111 of the plate 11. The first dielectric plate 12 and the plate 11 may be coupled by inserting the protrusions into the holes 111. A plurality of protrusions may be formed corresponding to the positions of the holes 111 of the plate 11. The plurality of protrusions may be formed integrally with the first dielectric plate 12.

A plurality of radiation elements 14 may be arranged in a row along the first direction. In this case, the plurality of radiation elements 14 may form one antenna column. Here, the first direction is a direction parallel to the Y-axis of FIG. 1.

When the intermediate frequency of the operating frequency band is lambda, within one antenna column, if the gap between one radiation element 14 and its neighboring radiation element 14 is equal to or more than 1 lambda, undesirable grating lobes may occur in the radiation pattern.

Therefore, it is preferable that the gap between one radiation element 14 and its neighboring radiation element 14 in the first direction is less than 1 lambda. However, the present disclosure is not limited to the above, and the gap in the first direction between the two radiation elements 14 may have a value outside the above-described range.

The antenna device 1 may include a plurality of antenna columns. A plurality of antenna columns may be arranged on the plate 11 along a second direction perpendicular to the first direction. In this case, the second direction is a direction parallel to the X-axis of FIG. 1.

The plurality of radiation elements 14 may be configured to implement dual polarization. The first feed line 13 may be configured as a pair so that the radiation element 14 implements dual polarization. The pair of first feed lines 13 may be arranged symmetrically. For example, two types of polarized signals of +45 degrees and −45 degrees may be radiated from one radiation element 14. However, the present disclosure is not limited to the above, and the radiation element 14 may be configured to implement single polarization or quadruple polarization.

The first feed line 13 may be configured to supply power to a plurality of radiation elements 14. That is, the plurality of radiation elements 14 can transmit and receive signals or receive power using the first feed line 13.

The first feed line 13 may include a main line region 131, a connection line region 132, and an input/output region 133. The main line region 131 may extend longitudinally along the first direction. The connection line region 132 may have one end connected to the second connection unit 125 and the other end connected to the main line region 131. The connection line region 132 may be formed by bending the main line region 131 at a predetermined angle. For example, the connection line region 132 may be formed by bending the main line region 131 into an ‘L’ shape. However, the present disclosure is not limited to the above, and the connection line region 132 may be formed obliquely.

The connection line region 132 may be branched from the main line region 131, and each connection line region 132 may be connected to the corresponding radiation element 14. The connection line region 132 may be directly connected to the radiation element 14, or may be connected by a coupling method.

The input/output region 133 may be branched from the main line region 131 and may connect an RF circuit to the main line region 131. One end of the input/output region 133 may be connected to the main line region 131, and the other end of the input/output region 133 may be connected to the RF circuit provided with a filter, a power amplifier, a power supply unit, and the like.

The RF circuit may be provided inside the antenna device 1, but may also be provided in an external device outside the antenna device 1, for example, a remote radio head (RRH). When the RF circuit is provided in an external device such as the RRH, the antenna device 1 and the external device with the RF circuit may be connected using an RF cable, a connector, or the like.

The input/output region 133 may transmit signals transmitted from the RF circuit to the plurality of radiation elements 14 or transmit signals received them from the plurality of radiation elements 14 to the RF circuit, using the main line region 131 and the connection line region 132. In addition, the input/output region 133 may supply power to the plurality of radiation elements 14 using the main line region 131 and the connection line region 132.

In order to minimize phase difference or power loss that may occur due to an increase in the length of the first feed line 13, the input/output region 133 may be disposed near the middle portion of the main line region 131.

Meanwhile, in the air-strip line structure, the dielectric portion is implemented as air, so the length of the first feed line 13 for inputting the same phase to the plurality of radiation elements 14 may be relatively long.

For example, when the intermediate frequency of the operating frequency band is lambda, the length of the first feed line 13 required to input signals of the same phase to the first radiation element and the second radiation element adjacent to the first radiation element may be 1 lambda. That is, the length of the first feed line 13 from the first connection line region and the second connection line region adjacent to the first connection line region may be 1 lambda.

As described above, in order to minimize the occurrence of grating lobes, the gap in the first direction between two adjacent radiation elements 14 is preferably less than 1 lambda. In this case, the length of the first feed line connecting the two adjacent radiation elements 14 may be longer than the gap between the two adjacent radiation elements 14, which may be a problem.

To solve this problem, the main line region 131 may include a delay line. The delay line may be formed in at least a portion of the main line region 131. The delay line may be an area formed by bending a portion of the main line region 131, and may partially compensate for the length of the first feed line 13, which has become longer.

In a pair of first feed lines 13, the delay line may have a concave shape or a convex shape toward the other first feed line 13. For example, the delay line may have a ‘C’ shape, but the present disclosure is not limited thereto.

With the main line region 131 including the delay line, the distance between the two adjacent radiation elements 14 in the first direction can be prevented from inevitably increasing. Accordingly, the antenna device 1 can be compact, and the occurrence of undesirable grating lobes can be minimized.

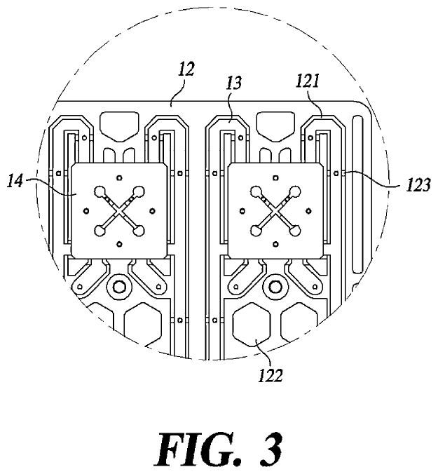

FIG. 3 is an enlarged top view of part B of FIG. 1.

Referring to FIG. 3, the first feed line 13 of the antenna device 1 of the present disclosure may be configured to float in the first groove 121. The first feed line 13 may float at a predetermined distance from the side wall of the first groove 121. The first support unit 123 may support the first feed line 13 so that the first feed line 13 can float at the predetermined distance from the side wall of the first groove 121.

The antenna device 1 of the present disclosure may vary the impedance by adjusting the gap between the first feed line 13 and the side wall of the first groove 121 while maintaining the width of the first feed line 13 constant. The first feed line 13 may have a uniform width. Therefore, unlike a conventional air-strip line structure in which the width of the feed line is adjusted to vary the impedance, there is an effect of minimizing a height difference that occurs when manufacturing the first feed line 13. Accordingly, the antenna device 1 of the present disclosure can also minimize burr problems that occur when manufacturing the air-strip line structure.

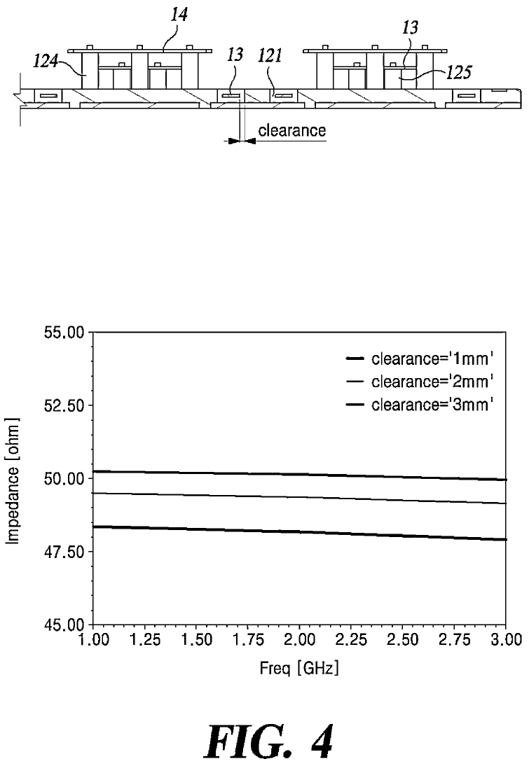

FIG. 4 is a cross-sectional view taken along line AA′ of FIG. 1 and a graph showing the change in impedance according to the distance between the feed line and the dielectric plate.

Referring to FIG. 4, the antenna device 1 of the present disclosure is capable of adjusting the distance between the first feed line 13 and the side wall of the first groove 121. Since the width of the first feed line 13 is constant, the width of the first groove 121 needs to be adjusted to adjust the distance between the first feed line 13 and the side wall of the first groove 121. For example, the distance between the first feed line 13 and the side wall of the first groove 121 can be increased or decreased by adjusting the thickness of the side wall of the first groove 121. The width of the first groove 121 can be designed using a preset value during the manufacturing process of the first dielectric plate 12.

Referring to the graph of FIG. 4, it can be seen that the impedance increases as the distance (clearance) between the first feed line 13 and the side wall of the first groove 121 increases. That is, the antenna device 1 of the present disclosure can adjust the dielectric constant and impedance by adjusting the distance between the first feed line 13 and the side wall of the first groove 121.

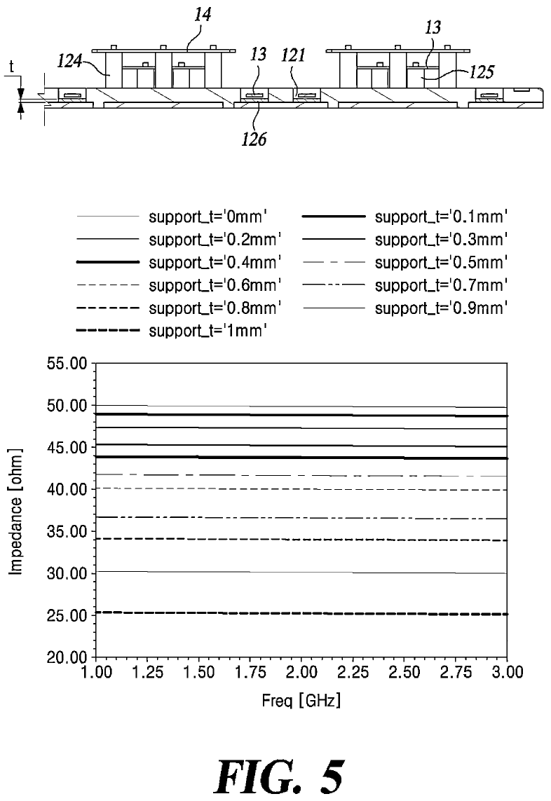

FIG. 5 is a graph showing a dielectric portion added to the bottom of the feed line and a change in impedance change depending on the thickness of the dielectric portion according to one embodiment of the present disclosure.

Referring to FIG. 5, the first dielectric plate 12 of the antenna device 1 of the present disclosure may further include a dielectric portion 126.

The dielectric portion 126 may be formed in the first groove 121. The dielectric portion 126 may be formed at the bottom of the first groove 121 and may connect opposing side walls of the first groove 121. The dielectric portion 126 may be integrally formed with the first dielectric plate 12 to be connected to the first groove 121, and the thickness of the dielectric portion 126 may be thinner than the thickness of the first groove 121.

The dielectric portion 126 may be formed in at least a portion of the first groove 121 where the first support unit 123 is not formed. The dielectric portion 126 may be formed continuously or may be formed regularly at predetermined intervals. The dielectric portion 126 may be formed at the bottom of the first dielectric plate 12 to be spaced apart by predetermined distance from the first feed line 13. The shape and thickness of the dielectric portion 126 may be designed in various ways as needed.

Referring to the graph of FIG. 5, it can be seen that the impedance varies depending on the distance between the first feed line 13 and the dielectric portion 126. It can be seen that as the thickness t of the dielectric portion 126 increases, that is, as the distance between the first feed line 13 and the dielectric portion 126 decreases, the impedance increases. That is, the antenna device 1 of the present disclosure can adjust the dielectric constant and impedance by adjusting the distance between the first feed line 13 and the dielectric portion 126.

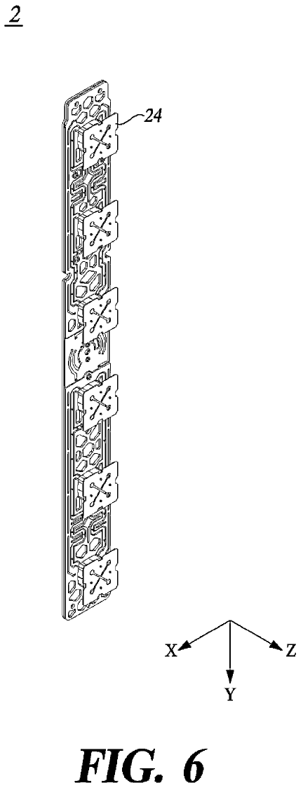

FIG. 6 is a combined perspective view of an antenna device according to another embodiment of the present disclosure.

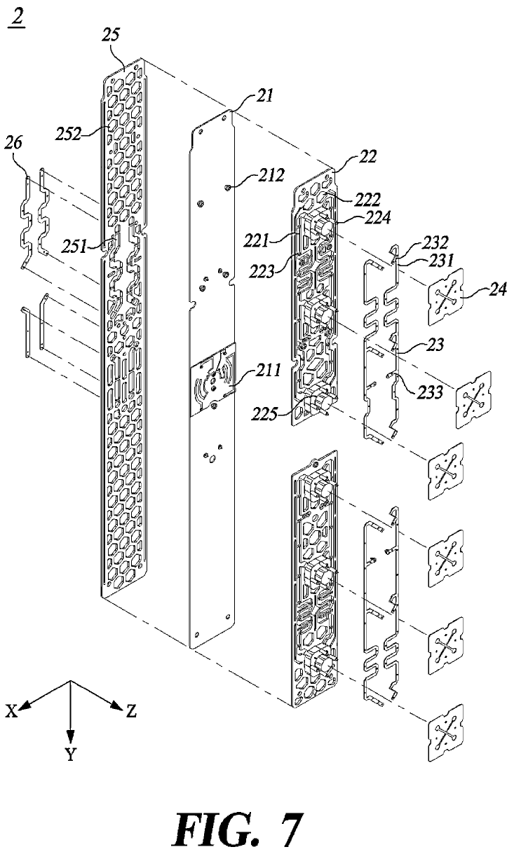

FIG. 7 is an exploded perspective view of the antenna device according to another embodiment of the present disclosure.

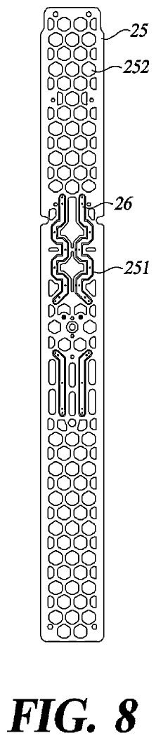

FIG. 8 is a bottom view of the antenna device according to another embodiment of the present disclosure.

Referring to FIGS. 6 to 8, the antenna device 2 according to another embodiment of the present disclosure includes all or some of a plate 21, a first dielectric plate 22, a first feed line 23, a plurality of radiation elements 14, a second dielectric plate 25, and a second feed line 26.

The first dielectric plate 22 may include all or some of a first groove 221, a second groove 222, a first support unit 223, a first connection unit 224, and a second connection unit 225. The first feed line 23 may include a main line region 231, a connection line region 232, and an input/output region 233.

In the descriptions of the plate 21, the first dielectric plate 22, the first feed line 23, the plurality of radiation elements 14, and each configuration of the antenna device 2 according to another embodiment of the present disclosure, descriptions of parts overlapping with the antenna device 1 according to one embodiment of the disclosure are replaced with the contents described above. In addition, for convenience of explanation, only one antenna column is disposed in FIGS. 6 to 8, but the present disclosure is not limited to this and a plurality of antenna columns may be disposed.

The first dielectric plate 22 may be coupled to an upper surface of the antenna device 2, and the second dielectric plate 22 may be coupled to a lower surface. The first dielectric plate 22 and the second dielectric plate 25 may be respectively formed on the upper and lower surfaces of the plate 21 through double injection.

The plate 21 may include a variable circuit board 211 and a coupling portion 212. The variable circuit board 211 is a type of printed circuit board, and a variable circuit having at least one power disconnection point that can change the phase of the frequency using the feed lines 23 and 26 may be printed in a pattern on an upper surface of the variable circuit board 211. The variable circuit board 211 may be electrically connected to the first feed line 23 and/or the second feed line 26. The coupling portion 212 may couple the plate 21, the first dielectric plate 22, and the second dielectric plate 25. The coupling portion 212 may each have a pair of bolt/nut structure, but is not limited thereto and may have any structure capable of combining the plate 21, the first dielectric plate 22, and the second dielectric plate 25.

The second dielectric plate 25 may include all or part of a third groove 251 and a fourth groove 252. The third groove 251 and the fourth groove 252 may be formed integrally with the second dielectric plate 25. In this case, the second dielectric plate 25 may be made of a dielectric material, for example, a plastic material.

The third groove 251 may be formed to penetrate upper and lower surfaces of the second dielectric plate 25. The third groove 251 may extend longitudinally along the first direction. In this case, the first direction is a direction parallel to the Y-axis of FIG. 7. The third groove 251 may be formed to correspond to the shape of the second feed line 26 so that the second feed line 26 can float in the third groove 251.

The second feed line 26 may be configured to float in the third groove 251. For example, the second feed line 26 may float at a predetermined distance from the side wall of the third groove 251. In addition, the second feed line 26 may float at a predetermined distance from the plate 21 coupled to the lower surface of the second dielectric plate 25.

The space between the second feed line 26 and the side wall of the third groove 251 and/or the plate 21 may be filled with air. That is, the second feed line 26 may have an air-strip line structure like the first feed line 23.

The fourth groove 252 may be formed in at least a portion of the second dielectric plate 25 where the third groove 251 is not formed. The fourth groove 252 may be formed to penetrate the upper and lower surfaces of the second dielectric plate 25. The fourth groove 252 may be formed regularly with a predetermined pattern. For example, the fourth groove 252 may be formed in a honeycomb-shaped pattern. However, the present disclosure is not limited to the above, and the fourth groove 252 may be formed irregularly. By forming a plurality of fourth grooves 252 in the second dielectric plate 25, the weight of the second dielectric plate 25 can be lightened and the manufacturing cost of the antenna device 2 can be reduced.

Unlike the first feed line 23, the second feed line 26 may not have a bent shape. The second feed lines 26 may be paired and be arranged symmetrically to each other. The second feed line 26 may extend longitudinally along the first direction. The second feed line 26 may be used when length compensation using the delay line of the first feed line 23 is not possible. By using the second feed line 26, a parallel feed design to be described later can be applied. For example, one end of the second feed line 26 may be connected to the input/output region 233 of the first feed line 23, and the other end may be connected to the RF circuit. The other end of the second feed line 26 may be connected to the RF circuit provided with a filter, a power amplifier, a power supply unit, and the like.

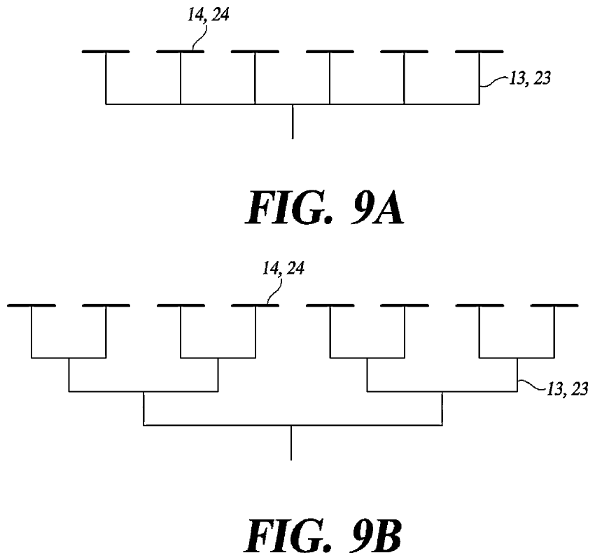

FIGS. 9A and 9B are diagrams showing the connection relationship of the feed lines according to one embodiment of the present disclosure.

FIG. 9A is a diagram schematically showing a circuit diagram when supplying power to the plurality of radiation elements 14 and 24 in series. In the case of series feeding, the gap between two adjacent radiation elements 14, 24 may be 1 lambda. In the case of series feeding, side lobes may occur due to a large phase difference between the plurality of radiation elements 14 and 24 on the phase slope, making it difficult to obtain a wide bandwidth of the antenna devices 1 and 2.

FIG. 9B is a diagram schematically showing a circuit diagram when supplying power to the plurality of radiation elements 14 and 24 in parallel. In the case of parallel feeding, the two adjacent radiation elements 14 and 24 may be identical in terms of phase. In the case of parallel feeding, the phase difference in the phase slope is gentle, so the antenna devices 1 and 2 can obtain a wide bandwidth.

Series feeding and parallel feeding can be applied to the antenna device 1 and the antenna device 2 according to one embodiment and another embodiment of the present disclosure, respectively. However, the present disclosure is not limited to this, and series feeding may be applied to the antenna device 2 according to another embodiment, or parallel feeding may be applied to the antenna device 1 according to one embodiment. In addition, series feeding and parallel feeding may be combined and applied to the antenna device 1 and the antenna device 2 according to one embodiment and another embodiment of the present disclosure.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### DESCRIPTION OF REFERENCE NUMERALS

| | |
|---|---|
| 1: antenna device | 11: plate |
| 111: hole | 12: first dielectric plate |
| 121: first groove | 122: second groove |
| 123: first support unit | 124: first connection unit |
| 125: second connection unit | 13: first feed line |
| 131: main line region | 132: connection line region |
| 133: input/output region | 14: radiation element |
| 2: antenna device | 21: plate |
| 211: variable circuit board | 22: first dielectric plate |
| 221: first groove | 222: second groove |
| 223: first support unit | 224: first connection unit |
| 225: second connection unit | 23: first feed line |
| 231: main line region | 232: connection line region |
| 233: input/output region | 24: radiation element |
| 25: second dielectric plate | 251: third groove |

What is claimed is:

1. An antenna device comprising:
a plate;
a first dielectric plate coupled to one surface of the plate;
a plurality of radiation elements arranged along a first direction on the first dielectric plate; and
a plurality of first feed lines configured to supply power to the plurality of radiation elements and having an air-strip line structure,
wherein the first dielectric plate includes a first groove penetrating upper and lower surfaces of the first dielectric plate and configured to allow the first feed line to float therein, and the first feed line is configured to float in the first groove.

2. The antenna device of claim 1, wherein the first feed line floats at a predetermined distance from a side wall of the first groove.

3. The antenna device of claim 1, wherein the first dielectric plate further includes a dielectric portion between the first feed line and the plate.

4. The antenna device of claim 1, wherein the first groove has a shape corresponding to a shape of the first feed line.

5. The antenna device of claim 1, wherein the first dielectric plate further includes one or more first support units formed in at least a portion of the first groove to support the first feed line.

6. The antenna device of claim 5, wherein the first support units are arranged at predetermined intervals and are formed integrally with the first dielectric plate.

7. The antenna device of claim 1, wherein the first dielectric plate further includes a first connection unit connecting the first dielectric plate to the radiation element and a second connection unit connecting the first dielectric plate to the first feed line, and
the first connection unit and the second connection unit are formed integrally with the first dielectric plate.

8. The antenna device of claim 1, further comprising a second dielectric plate coupled to the other surface of the plate and a plurality of second feed lines configured to transmit signals to the first feed line.

9. The antenna device of claim 8, wherein the second dielectric plate includes a third groove configured to penetrate upper and lower surfaces of the second dielectric plate in which the second feed line is disposed, and the second feed line is configured to float in the third groove.

10. The antenna device of claim 8, wherein the first dielectric plate and the second dielectric plate are injection molded.

11. The antenna device of claim 1, wherein the first feed line has a uniform width.

12. A feed line of an air-strip line structure which supplies power to a radiation element of an antenna device, the feed line comprising:
a dielectric plate;
a groove formed to penetrate through upper and lower surfaces of the dielectric plate; and
a line unit configured to float at a predetermined distance from a side wall of the groove.

13. The feed line of claim 12, further comprising one or more support units formed in at least a portion of the groove to support the line unit.

14. The feed line of claim 13, wherein the groove is formed to extend in a first direction, and
the support units are arranged at predetermined intervals along the first direction.

15. The feed line of claim 12, wherein the line unit has a uniform width.
